(19) United States
(12) Patent Application Publication
(10) Pub. No.: US 2015/0007054 A1
(43) Pub. Date: Jan. 1, 2015

(54) Capture, Store and Transmit Snapshots of Online Collaborative Sessions

(71) Applicant: Cisco Technology, Inc., San Jose, CA (US)

(72) Inventors: Jingbin Qu, Hangzhou (CN); Jianjun Jiang, Hangzhou (CN); Xi Wu, Hangzhou (CN); Bin Xu, Hangzhou (CN)

(21) Appl. No.: 13/927,388

(22) Filed: Jun. 26, 2013

(51) Int. Cl. H04L 29/06

(52) U.S. Cl. CPC H04L 65/4053
USPC 715/753

(57) ABSTRACT

A visual online collaborative session stream is received at a first client application over a network. An image of the visual collaborative session stream is captured at the first client application. The captured image is locally stored. The image is transmitted from the first client application to a second client application over the network.

### TECHNICAL FIELD

The present disclosure relates online collaborative sessions, such as online meetings and presentations. More specifically, the present disclosure relates to capturing snapshots of the visual content of the online sessions.

### BACKGROUND

In online collaborative sessions, an online host or presenter is generally responsible for the content and pacing of the session. For example, the presenter of an online presentation will determine the speed at which the slides are displayed, as well as when and how the session participants are allowed to ask questions. Furthermore, given that online presentations may be multicast to hundred or even thousands of participants, it may not be feasible to allow participants to ask questions during the presentation.

Accordingly, many on-line collaborative sessions conclude with a question-and-answer period. Unfortunately, by the time the collaborative sessions conclude, the participants may have forgotten their questions. Additionally, when asking a question during the question-and-answer period, it may be helpful to be able to refer to and display specific portions of the presentation. Yet, because the participants do not have control over the presentation content, it may be difficult to ask the presenter to move backwards in the presentation to the slide that should best accompany the participant's question. Even if the presenter is able to move backwards through the presentation to the slide associated with the participant's question, the time taken to find the slide is wasted, and may result in some participants leaving the collaborative session before the question-and-answer period is concluded.

### BRIEF DESCRIPTION OF THE DRAWINGS

FIG. 1 is block diagram of a system configured to capture, store and transmit snapshots of collaborative online sessions.

FIG. 2 depicts a flowchart illustrating a process for capturing, storing and transmitting a snapshot of an online collaborative session.

FIG. 3 depicts a display screen provided by a collaborative online session client application including a toolbar to receive user input to capture a snapshot of an online collaborative session.

FIG. 4 depicts a second display screen provided by a collaborative online session client application including a user input box configured to receive textual information associated with a snapshot of an online collaborative session from a user.

FIG. 5 depicts a third display screen provided by a collaborative online session client application including a thumbnail display area displaying a thumbnail of a snapshot of an online collaborative session and a text box displaying text previously associated with the snapshot.

FIG. 6 depicts a fourth display screen provided by an online collaborative session client application including an image transmit box configured to receive user input to transmit a snapshot of an online collaborative session to another online collaborative session client.

FIG. 7 depicts a device configured to capture, store and transmit snapshots of collaborative online sessions.

### DESCRIPTION OF EXAMPLE EMBODIMENTS

### Overview

A visual online collaborative session stream is received at a first client application over a network. An image of the visual collaborative session stream is captured at the first client application. The captured image is locally stored. The image is transmitted from the first client application to a second client application over the network.

Because the snapshots are locally stored, according to some examples, the meeting participants have control over the snapshots. Accordingly, additional information can be stored in association with the snapshots. For example, if a snapshot is captured because the content of the snapshot is related to a specific question of the session participant, textual information explaining the participant's question can be stored and associated with the snapshot. Furthermore, because the snapshots are locally stored, they can be easily accessed by the participant even after the online collaborative session has concluded.

According to some examples, the snapshots may be captured from a buffer associated with the client application. Accordingly, information on the user's display screen not associated with presentation may not be included in the snapshot. For example, while many computing devices allow a user to take a screenshot, the screenshot will include all of the application information currently being displayed to the user, including information for applications not associated with the online collaborative session. By capturing snapshots from the buffer associated with the online collaborative session client application, snapshots may be captured that only include data from the online collaborative session.

### Example Embodiments

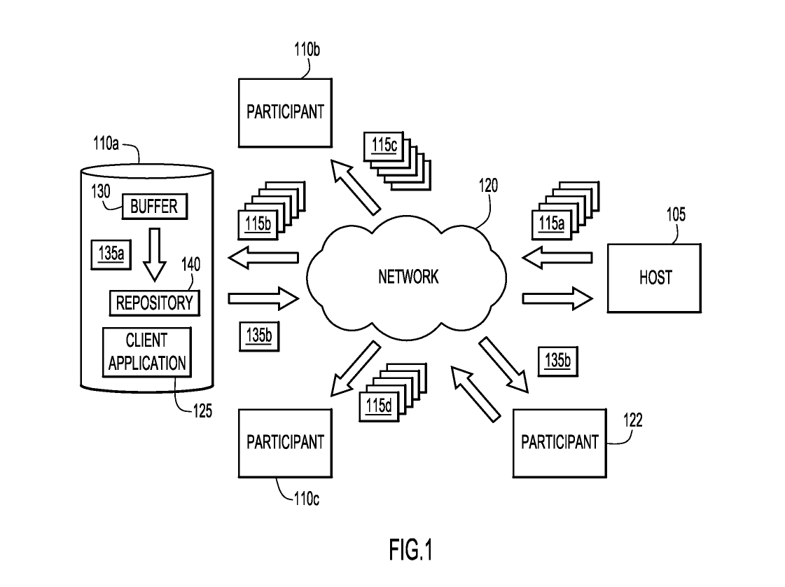

Depicted in FIG. 1 is a host 105 and participants 110a-c configured for participating in a visual online collaborative session, such as a real-time collaborative session. The host 105 and participants 110a-c are further configured to capture images or “snapshots” of the visual collaborative session stream. Each of the host 105 and participants 110a-c are further configured to locally store the snapshots, and to subsequently share the snapshots with the host 105 and participants 110a-c.

Specifically, host 105 provides a visual online collaborative session stream 115a-d through network 120. According to the example of FIG. 1, the visual collaborative online session is initiated from host 105 via stream 115a and multicast to participants 110a-c through individual streams 115b-d. Streams 115a-d contains visual presentation data, but may also include audio data, and other data, such as data used to control a participant's local computing device or data used to update documents on the participant or host devices. In order to receive streams 115b-d and participate in the online collaborative session, each participant includes a client application and a buffer, such as client application 125 and buffer 130, both illustrated for participant 110a. Specifically, stream 115b is received at buffer 130 and displayed through client application 125.

According to some examples, host 105 may first transmit stream 115a to collaborative session server 122. Collaborative session server 122 then multicasts streams 115b-d to participants 11a-c, respectively. Collaborative session server 122 may also send a copy of stream 115a back to host 105, so host 105 can see the same presentation being received by participants 110a-c. Collaborative session server 122 may also provide additional functionality, such as authenticating meeting participants and recording an archive copy of stream 115a.

In order to generate a snapshot 135a, client application 125 accesses data from stream 115b that has been stored in buffer 130. Image file or snapshot 135a is generated from the stream data, and locally stored at participant 110a. Specifically, file 135a containing image data is stored in repository 140 of participant 110a. The file 135a may contain binary image data such as data stored according to the Joint Photographic Expert Group (JPEG) format. According to other examples, file 135a may be a Tagged Image File Format (TIFF) file, a Graphics Interchange Format (GIF) file, or other image or video file types.

During the visual online collaborative session, a user associated with participant 110a may wish to share image 135a with host 105, as well as the other participants 110b and c. For example, during the online collaborative session, the user associated with participant 110a may have caused participant 110a to take a snapshot of a portion of the session about which the user had a question. Accordingly, during a “question-and-answer” portion of the online collaborative session, the user associated with participant 110a may wish to share image 135a with host 105 and participants 110b and 110c to better illustrate the question. In order to share image 135a, participant 110a sends image 135b to host 105, as well as participants 110b and 110c. In the example depicted in FIG. 1, image 135b is first sent to collaborative session server 122. Collaborative session server 122 then sends image 135b to host 105 and participants 110b and 110c. According to other examples, participant 110a may directly multicast image 135b to each of the desired participants.

Once host 105 and participants 110b and 110c receive image 135b, the user associated with participant 110a may clearly present the question in conjunction with image 135b displayed by each of host 105 and participants 110b and 110c. Furthermore, because participant 110a sends a self-contained image 135b, the content of image 135a can be displayed without requiring the presenter or collaborative session server to waste time and/or resources moving backwards through the previously displayed presentation data.

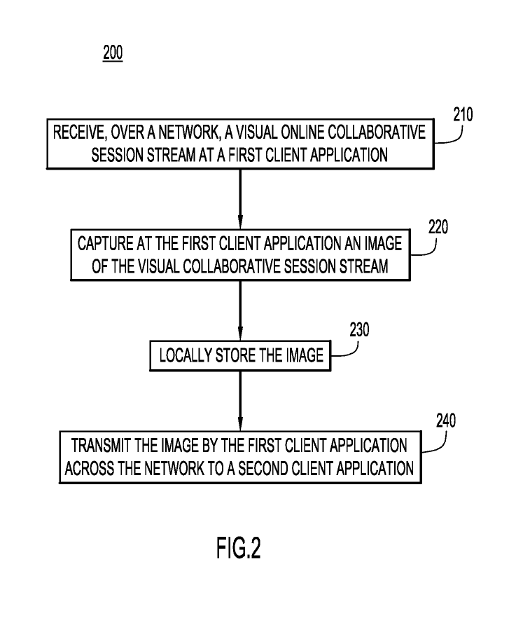

With reference now made to FIG. 2, depicted therein is a flowchart 200 illustrating process steps for carrying out snapshot capture, such as the snapshot capture described above in reference to FIG. 1. Specifically, flowchart 200 illustrates the process steps that are performed by an online collaborative session participant, such as participant 110a of FIG. 1.

The process begins in step 210, in which a visual online collaborative session stream is received over a network at a first client application, such as the client application 125 of FIG. 1. Of course, the visual online collaborative session stream may also include more than just visual data. For example audio data and/or data used to control a participant's device may also be included in the stream. Once received at the first client application, the stream may be stored in a buffer associated with the first client application. The buffer may then be accessed in order to display the visual data contained in the stream to a user interacting with the first client application.

Moving to step 220, the first client application captures an image of the visual collaborative session. In order to capture the image, the first client application may access the buffer associated with first client application so that only image data associated with the stream is included in the captured image. For example, if the first client application is running on a personal computing device, such as a personal computer, a laptop computer, or a smartphone, the display of the personal computing device may display more than just the content of the visual collaborative session. If the first client application were to simply take a screen shot of the personal computing device's entire display, additional visual information may be captured in the snapshot. By accessing the buffer associated with the first client application, the snapshot can be limited to the just the content of the visual online collaborative session stream.

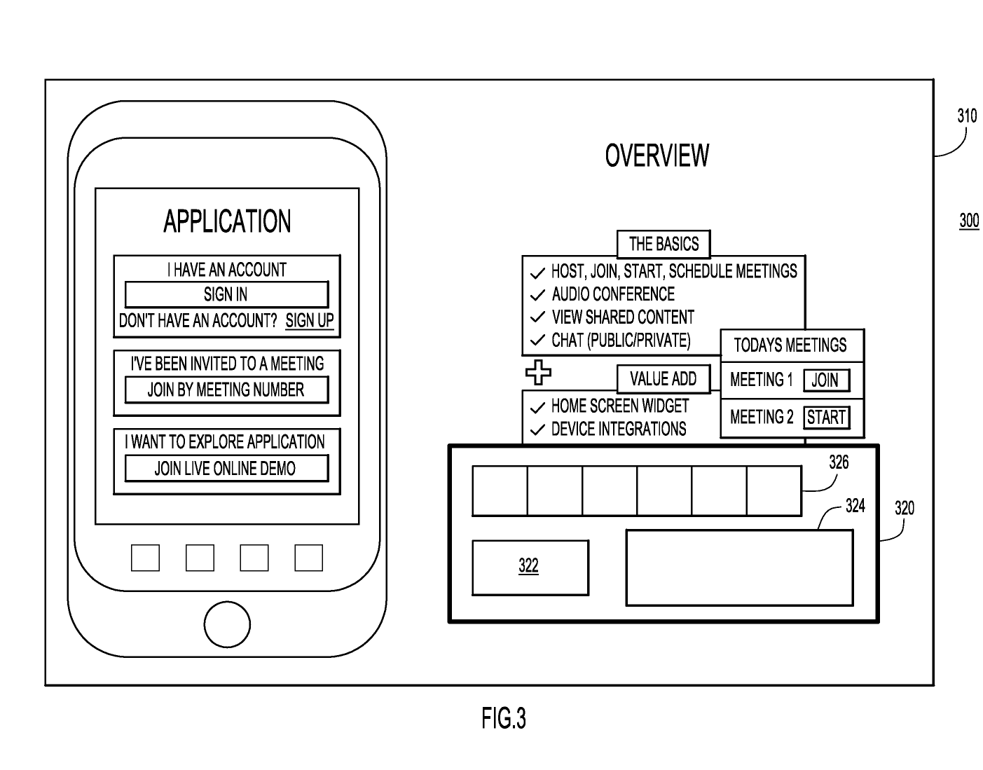

To better illustrate a specific example of capturing a snapshot, reference is now made to FIG. 3. Depicted in FIG. 3 is an example graphical user interface of a client application that allows for the capture of an image as described above in reference to step 220 of FIG. 2. Specifically, display screen 300 is displaying the contents 310 of an online collaborative session stream. According to the example of FIG. 3, slides describing a new smartphone application are being displayed through the client application. Also displayed by the client application is a snapshot tool bar 320. The snapshot tool bar may be configured to “float” or be moved by the user so that it does not block important portions of the contents 310 of the online collaborative session stream. Included in the snapshot toolbar are an action button 322, a text display area 324, and a snapshot thumbnail display area 326.

When a user clicks the action button 322, a snapshot is taken of the currently displayed portion of the visual online collaborative session stream. In response to the user's click of action button 322, the client application may access the buffer in which the visual online collaborative session stream data is stored, and generate the snapshot from the buffer data. Because the client application accesses the buffered online collaborative session data, the toolbar 320 and other application data can be easily omitted from the snapshot.

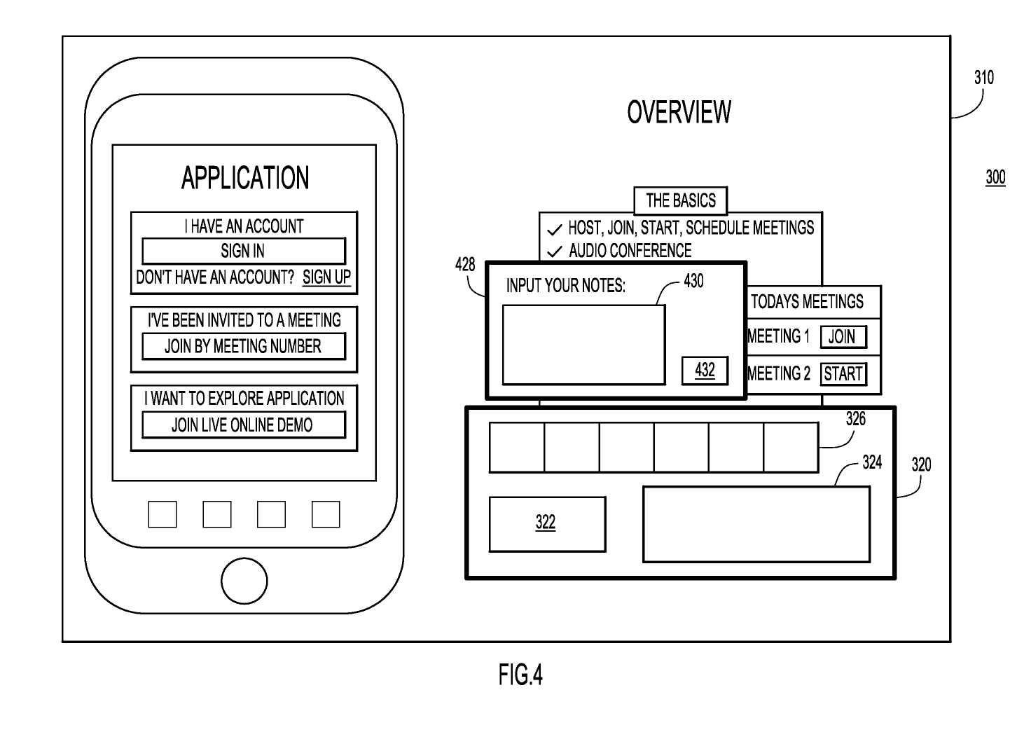

Once the image is captured, the client display may change to the display screen illustrated in FIG. 4. As depicted in FIG. 4, a user input box 428 may be displayed by the client application. Included in user input box 428 are a text box 430 and a text save button 432. Text box 430 allows the user to input notes or other text that will be associated with captured image. For example, if the user captures the image because they had a question related to the content of the portion of the collaborative session displayed in the captured image, text box 430 can be used to enter the specific question that prompted the user to capture the image. Of course, text box 430 may also be used to capture other textual information that the user wishes to associate with the captured image. The user may click the text save button 432 to indicate that they have completed entering their desired text.

Returning back to FIG. 2, in step 230, the captured image or snapshot is locally stored. For example, the first client application may include a repository, such as repository 140 of FIG. 1, in which captured images may be locally stored. The storing of the captured image may also include storing textual information associated with the image, such as textual information acquired through text box 430 shown in the example of FIG. 4. By storing the image locally, the user is able to easily amend their textual information, delete the image, or otherwise interact with the captured image without using network resources. Furthermore, locally storing the image allows the user to have access to the stored image even after the online collaborative session is over, and when the user is no longer connected to a network.

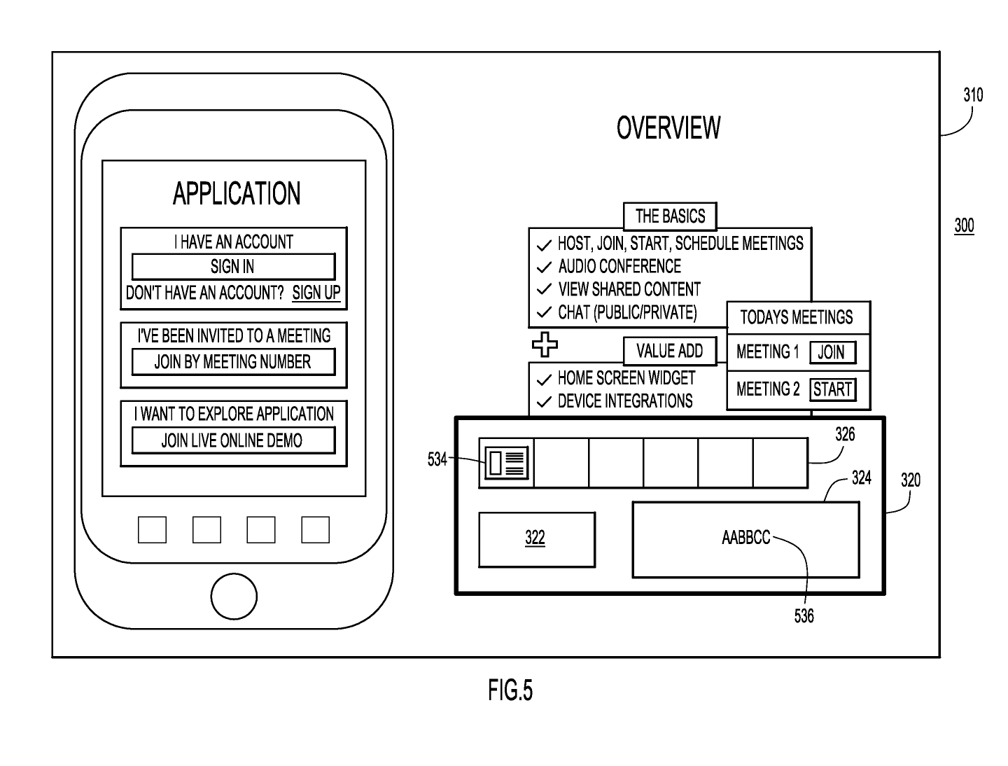

With reference now made to FIG. 5, depicted there is the graphical user interface of client application after an image is captured and locally stored. Specifically, a captured image thumbnail 534 is displayed in thumbnail display area 326. The captured image thumbnail may serve multiple purposes. According to one such purpose, displaying captured image thumbnail 534 serves as an indication to the user that the image depicted in thumbnail 534 was previously captured. It also allows the user to interact with the captured image. For example, when captured image thumbnail 534 is selected, any textual information previously associated with the captured image may be displayed as text 536 in text box 324.

Text 536 may comprise text entered by the user, such as text entered as described above in reference to FIG. 4, or text automatically generated by the client application. Automatically generated text may include an indication of the date and time when the image was captured, the name or subject of the online visual collaborative session from which the image was captured, and/or any legal terms associated with the captured image.

For example, if the online collaborative session includes proprietary or confidential information, the client application may automatically determine this from the online collaborative session stream, and include an indication of the protected nature of the content in text 536. Similarly, if the online collaborative session includes an indication that the content of the collaborative session is copyrighted, the copyright information may be included in text 536. Other automatically generated textual information may include identifying information such as the user that captured the image or the network address of the client application that captured the image.

Text box 324 may also allow the user to manually update or change text 536. For example, if the user added a question associated with the snapshot through text box 430 of FIG. 4, and the question is subsequently answered during the presentation, the user may update text 536 to include the answer to the user's previously entered question.

Once again returning to FIG. 2, in step 240 the first client application transmits the captured image across the network to a second client application. The transmission of the captured image may include transmission of textual information associated with the captured image, or according to other embodiments, the textual information may be omitted from the transmission. Whether or not the textual information is transmitted with the image may be determined based on the content of the textual information. For example, the user may indicate that user entered textual information should not be transmitted with the image while automatically generated textual information should be transmitted.

In order to transmit the captured image, the first client application may make use of the data transmission channel already established to receive the online collaborative session stream. For example, if a particular port and/or protocol are used for the online collaborative session stream, the image data may be packetized according to the session protocol, and transmitted over the session port. Similarly, if the first client application and the second client application allow for the presenter of the online collaborative session to be changed between the user of the first client application and a user of the second application, this functionality may be leveraged to allow the first client application to transmit the captured image as a presenter. Additionally, the transmission of the client application may comprise a multicast transmission from the first client application to a plurality of second client applications. According to other examples, the first client application will transmit the captured image to a host or collaborative session server, and the host or server will include the captured image in the collaborative session stream for receipt by one or more second client applications.

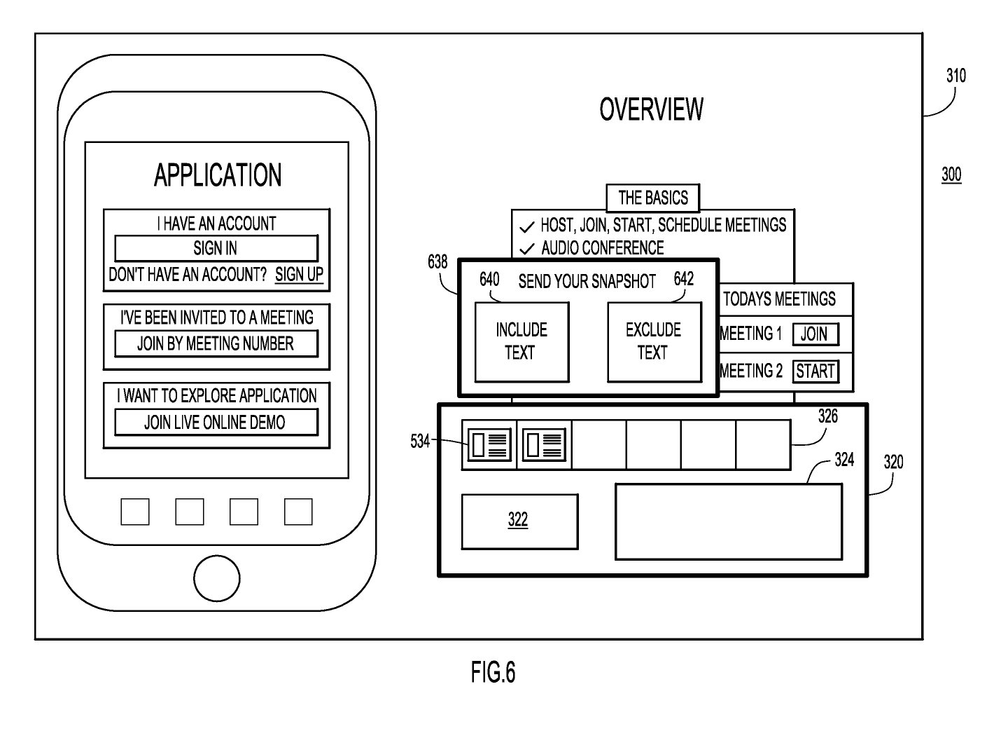

With reference now made to FIG. 6, depicted therein is the graphical user interface display screen 300 of the client application which includes image transmit box 638. When a user indicates that a captured image should be transmitted, for example, by double clicking image thumbnail 534, the client application may display image transmit box 638. Transmit box 638 allows the user of the client application to select options for the transmission of the image, and confirm the transmission. For example, transmit box 638 allows the user to choose between including or excluding the text displayed in text box 324 with the transmitted image. By selecting the “Include Text” action button 640 the user may initiate transmission of the image including text 536, while selection of the “Exclude Text” action button 642 may initiate transmission without text 536. Transmit box 638 may also allow user to select other options for the transmission of the image, including designating recipients and designating an image format.

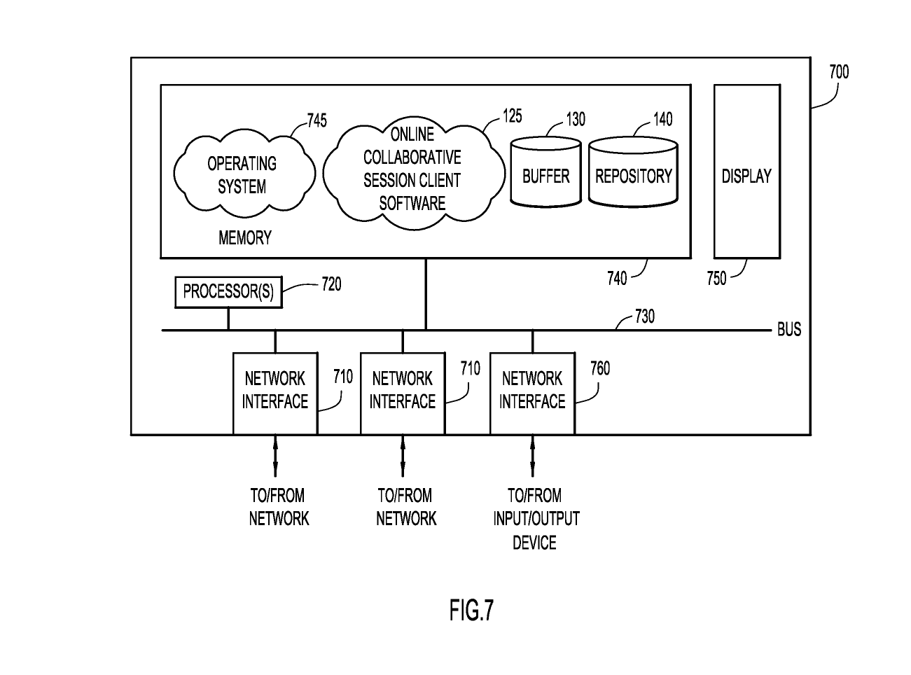

Turning now to FIG. 7, an example block diagram is shown of an apparatus, e.g., an online collaborative session endpoint device 700 configured to perform the techniques described herein in connection with FIGS. 1-6. The online collaborative session endpoint 700 comprises one or more network interface units 710 (e.g., network interface cards) to enable communication over a network, processor(s) 720, bus 730, and memory 740. The memory 740 contains or is encoded with software instructions for operating system 745 and online collaborative session client software 750. Memory 740 also contains the online collaborative session client buffer 130 and online collaborative session snapshot repository 140.

Also included in online collaborative session endpoint 700 are display 750 and user input/output unit 760. Display 750 allows the online collaborative session client software 750 to render the graphical user interface of the client software 125, including the visual content of an online collaborative session stream to the user. User input/output unit 760 interfaces with input/output device, such as keyboards, computer mice, speakers, and microphones, which allow a user to interact with the online collaborative session client software 750. For example, the user inputs described above with reference to FIGS. 1-6 may be received from devices connected to the online collaborative session endpoint 700 through user input/output unit 760.

Memory 740 may comprise read only memory (ROM), random access memory (RAM), magnetic disk storage media devices, optical storage media devices, flash memory devices, electrical, optical, or other physical/tangible (e.g., non-transitory) memory storage devices. The processor 720 is, for example, a microprocessor or microcontroller that executes instructions for the online collaborative session client software 125. Thus, in general, the memory 740 may comprise one or more tangible (non-transitory) computer readable storage media (e.g., a memory device) encoded with software comprising computer executable instructions and when the software is executed (by the processor 720), and in particular online collaborative session client software 125, it is operable to perform the operations described herein in connection with FIGS. 1-6.

The above description is intended by way of example only.

What is claimed is:

1. A method comprising:
receiving, over a network, a visual online collaborative session stream at a first client application;
capturing at the first client application an image of the visual collaborative session stream;
locally storing the image; and
transmitting the image by the first client application across the network to a second client application.

2. The method of claim 1, wherein capturing the image comprises creating an image file from a portion of the collaborative session stream stored in a buffer at the first client application.

3. The method of claim 1, further comprising receiving user input textual information associated with the image by the first client application.

4. The method of claim 3, wherein transmitting the image comprises transmitting the image and textual information to the second client application.

5. The method of claim 1, wherein transmitting the image comprises transmitting the image by the first client application during the collaborative session in which the image was captured.

6. The method of claim 1, wherein locally storing the image comprises adding the image to a repository of images captured during the collaborative session.

7. The method of claim 6, further comprising displaying in a graphical user interface window associated with the first client application a thumbnail of the image.

8. The method of claim 7, further comprising receiving a user selection of the thumbnail corresponding to the image,
wherein transmitting comprises transmitting the image in response to the user selection of the thumbnail.

9. The method of claim 7, further comprising:
receiving a user selection of a thumbnail corresponding to the image; and
receiving user input textual information associated with the image by the first client application.

10. The method of claim 1, wherein receiving comprises receiving a visual online collaborative session stream for a real-time collaborative session.

11. An apparatus comprising:
a memory;
a network interface unit configured to enable communications over a network; and
a processor coupled to the memory and the network interface unit, and configured to:
receive over the network via the network interface unit a visual online collaborative session stream;
capture an image of the visual collaborative session stream;
locally store the image in the memory; and
cause the network interface unit to transmit the image across the network to a second apparatus.

12. The apparatus of claim 11, further comprising a visual online collaborative session buffer;
wherein the processor is further configured to capture the image of the visual collaborative session stream from the visual online collaborative session buffer.

13. The apparatus of claim 11, further comprising an input/output unit;
wherein the processor is further configured to receive user input textual information associated with the captured image through the input/output unit; and
wherein the processor is further configured to locally store the user input textual information.

14. The apparatus of claim 13, wherein the processor is further configured to transmit the stored user input textual information to the second apparatus.

15. The apparatus of claim 11, further comprising a display;
wherein the processor is further configured cause the display to render a graphical user interface that displays the visual online collaborative session stream and a thumbnail of the image; and
wherein the processor is configured to receive a user selection of the thumbnail of the image, and cause the image to be transmitted in response to receiving the user selection.

16. A tangible computer readable storage medium encoded with instructions, that when executed by a processor, cause the processor to:
receive over a network a visual online collaborative session stream;
capture an image of the visual collaborative session stream;
locally store the image; and
cause the image to be transmitted across the network to an online session client application.

17. The computer readable storage medium of claim 16, wherein the instructions further cause the processor to capture the image of the visual collaborative session stream from a visual online collaborative session buffer.

18. The computer readable storage medium of claim 16, wherein the instructions further cause the processor to:
receive user input textual information associated with the captured image; and
locally store the user input textual information.

19. The computer readable storage medium of claim 18, wherein the instructions further cause the processor to transmit the stored user input textual information to the online session client application.

20. The computer readable storage medium of claim 16, wherein the instructions further cause the processor to:
display a graphical user interface which renders the visual online collaborative session stream and a thumbnail of the image;
receive a user selection of the thumbnail of the image; and
transmit the image in response to receiving the user selection.
